(19) United States
(12) Patent Application Publication
(10) Pub. No.: US 2019/0264096 A1
(43) Pub. Date: Aug. 29, 2019

(54) FRACTURING FLUID COMPOSITION COMPRISING A BIO-BASED SURFACTANT AND METHOD OF USE

(71) Applicant: Halliburton Energy Services, Inc., Houston, TX (US)

(72) Inventors: Sairam Eluru, Pune (IN); Chetan Prakash, Pune (IN); Rahul Chandrakant Patil, Pune (IN)

(21) Appl. No.: 16/326,278

(22) PCT Filed: Nov. 21, 2016
(86) PCT No.: PCT/US2016/063136

§ 371 Date: Feb. 18, 2019

(51) Int. Cl. C09K 8/68; C09K 8/80; C09K 8/60; E21B 43/267

(52) U.S. Cl. CPC C09K 8/685; C09K 8/80; C09K 2208/26; E21B 43/267; C09K 8/604

(57) ABSTRACT

This disclosure presents a well fracturing pad fluid, having a gelling agent; one or more buffering agents; a viscosity breaker; a biocide; a nonionic alkyl glycoside; and water, is present in the range from about 90% to about 99.9% by volume of the well fracturing pad fluid and methods of use.

### BACKGROUND

Hydraulic fracturing is a well-known process of pumping a fracturing or “fracking” fluid into a wellbore at an injection rate that is too high for the formation to accept without breaking. During injection the resistance to flow in the formation increases, the pressure in the wellbore increases to a value called the break-down pressure that is the sum of the in-situ compressive stress and the strength of the formation. Once the formation “breaks down,” a fracture is formed, and the injected fluid flows through it. From a limited group of active perforations, ideally a single, vertical fracture is created that propagates in two “wings” being 180° apart and identical in shape and size. In naturally fractured or cleated formations, it is possible that multiple fractures are created and/or the two wings evolve in a tree-like pattern with increasing number of branches away from the injection point.

Fluid not containing any solid (called the “pad”) is injected first, until the fracture is wide enough to accept a propping agent. The purpose of the propping agent is to keep apart the fracture surfaces once the pumping operation ceases, the pressure in the fracture decreases below the compressive in-situ stress trying to close the fracture. In deep reservoirs, man-made ceramic beads are used to hold open or “prop” the fracture. In shallow reservoirs, sand is normally used as the propping agent.

Typically fracturing fluids used for well stimulations consist primarily of water but also include a variety of well-known additives. The number of chemical additives used in a typical fracture treatment varies depending on the conditions of the specific well being fractured and typically constitutes a small volume of the fracturing fluid. For example, a typical fracture treatment will use very low concentrations of between 3 and 12 additive chemicals depending on the characteristics of the water and the formation being fractured. However, known fracturing fluid compositions can often present various collateral problems ranging from production to environmental concerns.

### BRIEF DESCRIPTION OF THE DRAWINGS

FIG. 1 illustrates a general view of a fracturing system associated with a well bore; and

FIG. 2 is a Rheology plot comparing a solution without a surfactant and one with the surfactant as disclosed herein.

### DETAILED DESCRIPTION

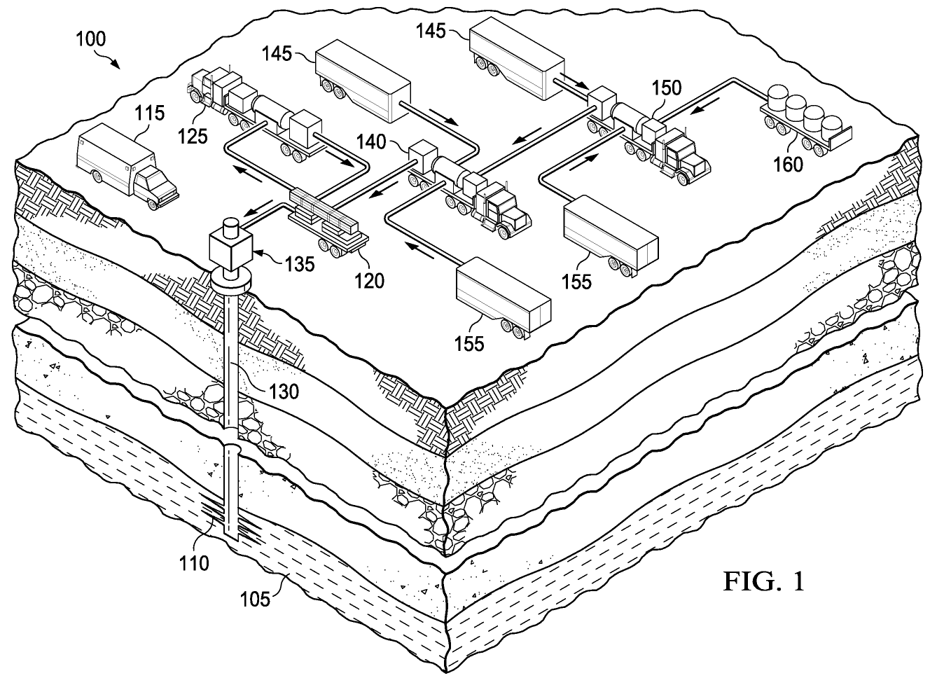

Fracturing fluids are often an integral part of drilling operations and have become even more so in view of advancements in drilling techniques that have led to large production capabilities of oil shales. FIG. 1 illustrates a conventional well completion system 100 in which the fracturing fluid of this disclosure may be used. Once a payzone 105 is identified or reached, a conventional fracturing operation may be used to create fractures 110 in the payzone 105 to increase its porosity for the purpose of increasing oil or gas production. Such completion environments 100 comprise, among other things, an operations control unit 115, a manifold unit 120, a frack pump 125, a wellbore 130, capped by a wellhead tree 135. The fracturing system also comprises a slurry blender system 140 where a hydrated gel is combined with the other fracturing additives and proppant. The slurry blender system 140 comprises one or more of the following: fluid tanks 145, a gel blender 150, and other fracking component storage tanks 155, such as chemical and sand storage tanks. A gel hydration apparatus 160 is couplable (i.e. can be coupled to) the slurry blender system 140. The fracturing fluid, as discussed below is used to fracture the payzone 105. The fracturing fluid, which includes a hydrated gel is pumped along with a proppant into the fractures 110 to prop the fissures open, thereby, effectively increasing its porosity. The fracturing fluids can be tailored or designed for any given fracturing application.

To create the fracture, a fracking fluid is pumped into the wellbore at a high rate to increase the pressure in the wellbore at the perforations to a value greater than the breakdown pressure of the formation. The breakdown pressure is generally believed to be the sum of the in-situ stress and the tensile strength of the rock. Once the formation is broken down and the fracture created, the fracture can be extended at a pressure called the fracture-propagation pressure. The fracture-propagation pressure is equal to the sum of the in-situ stress, plus the net pressure drop, plus the near-wellbore pressure drop. The net pressure drop is equal to the pressure drop down the fracture as the result of viscous fluid flow in the fracture, plus any pressure increase caused by tip effects. The near-wellbore pressure drop can be a combination of the pressure drop of the viscous fluid flowing through the perforations and/or the pressure drop resulting from tortuosity between the wellbore and the propagating fracture. Thus, the fracturing-fluid properties are important in the creation and propagation of the fracture.

The fracturing fluid should be compatible with the formation rock and fluid, generate enough pressure drop down the fracture to create a wide fracture, be able to transport the propping agent in the fracture, break back to a low-viscosity fluid for cleanup after the treatment, and be cost-effective.

To create a hydraulic fracture, fluid is injected at high rate and pressure into a wellbore and into a formation that is open to the wellbore. Viscous fluid flow within the fracture and tip effects create the net pressure required to generate the created width profile and the created fracture height. The volume of fluid pumped will affect the created fracture length. However, without pumping a propping agent into the fracture, the created fracture will close once the pumping operation ceases.

The first fluid pumped into a well during a fracture treatment is called the “prepad.” The prepad is used to fill the casing and tubing, test the system for pressure, and break down the formation. Next, the pad fluid, which is the viscous fracturing fluid used during the treatment, is pumped. No propping agent is added to the pad at this time. The purpose of the pad is to create a tall, wide fracture that will accept the propping agent. Following the injection of the fracking pad, the pad fluid containing the propping agent, which is called a slurry, is pumped into the fracture zone. The slurry moves into the fractures, transporting the propping agent. The particles move up, out, and down the fracture with the slurry. The particles also can settle in the fracture as a result of gravitational forces.

However, as mentioned above, problems arise when using conventional fracturing fluids. For example, reservoir treatment fluid and oil tend to emulsify when they come into contact. This can occur when the fracturing fluid contacts the hydrocarbons within the geological formation during the fracturing process, or when water based drilling muds come in contact with the hydrocarbons. Emulsification can also occur when high density brines/gels, through leak off, come into contact with hydrocarbons during gravel packing operations, or when acidic fluids contact the hydrocarbons during stimulation processes.

In all these cases, emulsions can be stabilized either by native surfactants present in the fluids or by fluid loss control additives/solids, or by the presence of asphaltenes. These emulsions may remain strongly associated with the formation and can impede oil flow and productivity. To avoid these emulsion formations, conventional non-emulsifiers are mixed with the treatment fluids. However, these conventional additives often have serious draw-backs, such as being ionic, having very low flash points of around 70° F., or they are not environmentally safe.

Embodiments of the fracturing fluid, as presented in this disclosure, comprise a bio-degradable, nonionic surfactant, non-emulsifier that has good foaming properties for subterranean applications and a high flash point, for example greater than about 200° F. This nonionic surfactant, non-emulsifier, which lowers the surface tension within the fluid, provides several advantages over conventional surfactants that are used in a fracking fluid. For example, the nonionic surfactant, non-emulsifiers, as provided herein, significantly improves the rheology of the fracking fluid at temperatures of around 270° F., thereby improving thermal stability. Additionally, they are naturally derived from renewable resources, 100% bio degradable, and contain no ethylene oxides and PEG groups, which helps make them environmentally safe. Further, they are active over a wide pH range and have a reduced surface tension of less than about dyne/cm. They are chemically flexible in that they can be used with all kinds of acids and alkaline formulations. They exhibit excellent non-emulsification properties, and provide good foaming properties, as demonstrated below.

In an embodiment, the fracturing fluid comprises water, a gelling agent, one or more buffering agents, a viscosity breaker, and a nonionic alkyl glycoside crosspolymer, which functions as a non-emulsification/surfactant agent within the fracturing fluid. The nonionic alkyl glycoside provides good foaming characteristics, while also providing good phase separation. As discussed below, other known fracturing fluid constituents may also be included in the fracturing fluid. The largest component by volume of the fracturing fluid is water and proppant. As used herein and in the claims, a proppant is an agent that “props open” the fracture once the pumps shut down and the fracture begins to close. The propping agent is typically strong, resistant to crushing, resistant to corrosion, has a low density, and is readily available at low cost. Examples of products that meet these desired traits are conventional materials, such as silica sand, resin-coated sand (RCS), and ceramic proppants.

In an embodiment, the nonionic alkyl glycoside crosspolymer comprises a sorbitan oleate bonded to one or more glucosides to form the alkyl glycoside crosspolymer. Sorbitan Oleate is a monoester of oleic acid and hexitol anhydride derived from sorbitol, which in an embodiment is 1,2-dihydroxyethyl]oxolane-3,4-diol. Other embodiments may include a number of other types of sorbitan oleates, such as sorbitan stearate, sorbitan laurate, sorbitan sesquioleate, sorbitan oleate, sorbitan yristearate, sorbitan palmitate and sorbitan trioleate.

The sorbitan oleate is bonded to one or more glucoside molecules. Non-limiting examples of glucosides include decylglucoside or laurylglucoside. In an embodiment, the sorbitan oleate is bonded to a decyl-glucoside on both sides of the sorbitan oleate structure to form decyl-glucoside sorbitan oleate crosspolymer, which is commercially available from Colonial Chemical Company and known as Poly Suga®Mulse D9, the structure of which is as follows:

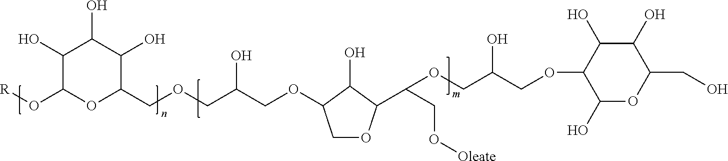

wherein, “n” may range from 1 to 50 and “m” may range from 1 to 50. In an alternative embodiment, however, the crosspolymer may be a lauryl-glucoside sorbitan oleate crosspolymer.

In one embodiment, the nonionic alkyl glycoside crosspolymer comprises from about 0.01% to about 10% by volume of the well fracturing fluid, and in one aspect of the embodiment, the nonionic alkyl glycoside is decyl-glucoside sorbitan oleate crosspolymer and has a concentration of about 2 gal/1000 gallons (hereinafter 1000 gal) of water in the fracking fluid.

In various embodiments of this disclosure, the nonionic glycoside crosspolymer's addition to the fracking fluid results in a fracking fluid having a flash point of greater than about 200° F. and a viscosity that ranges from about 800 cp to about 1100 cp at 270° F. A pH of the nonionic glycoside crosspolymer may range from about 6.0 to about 8.0.

In one embodiment, the gelling agent is a hydroxyl-propyl guar (including polysaccharides and their derivatives as well as synthetic polymers), cellulose synthetic polymers, or other polysaccharide that are well-know and often used in fracturing fluids. Gelling agents are used to viscosity the fluid. In one aspect of this embodiment, the gelling agent is present in the range from about 5 lb/1000 gal to about 500 lb/1000 gal of the fracking fluid In one aspect of this embodiment, the w/v is 40 lbs/1000 gal of water.

In certain embodiments, the buffering agents, which are used to control the pH of the fracking fluid, may be acetic acid, sodium bicarbonate, potassium carbonate, sodium hydroxide, or fumaric acid. Commercially available buffering agents are shown in Table I, below. In one embodiment, however, the buffering agents are acetic acid, potassium carbonate, and sodium hydroxide and are present in the range from about 0.01 gal/1000 gal to about 20 gal/1000 gal of the fracking fluid. In one aspect of this embodiment, these three buffering agents comprise about 5.2 gal/1000 gal of water. In other embodiments, the acetic acid is present in the range about 0.2 gal/1000 gal of water, the potassium carbonate comprises about 2.5 gal/1000 gal of water and the sodium hydroxide comprises about 2.5 gal/1000 gal of water.

In some embodiments, the viscosity breaker comprises chlorous acid, sodium salt, and sodium chloride. One commercially available viscosity breaker is shown in Table I, below. Breakers are used to break the polymers and crosslink sites at low temperature. In one embodiment, the viscosity breaker may be present in the range from about 0.01 gal/1000 gal to about 30 gal/1000 gal of the fracking slurry, and in one aspect of this embodiment, the viscosity breaker comprises about 2 gal/1000 gal of water. The viscosity breaker is used to reduce the molecular weight of guar polymer in the fracturing fluid by cutting the long polymer chain. As the polymer chain is cut, the fluid's viscosity is reduced to near that of water. This process can occur independent of crosslinking bonds existing between polymer chains. The water thin fluid can then be flowed from the fracture.

In some embodiments, the biocide, is glutaraldehyde and methanol and is used to kill bacteria in the mix water. One commercially available biocide is shown in Table I, below. In one embodiment, the biocide may be present in the range from about 0.01 gal/1000 gal to about 5 gal/1000 gal of the fracking fluid, and in one aspect where the biocide comprises glutaraldehyde and methanol, the biocide comprises about 0.1 gal/1000 gal of water.

In some embodiments, the fracking fluid may further comprise a conventional gel stabilizer/oxygen scavenger, such as sodium thiosulfate. A commercially available example of an oxygen scavenger is shown in Table I, below. The gel stabilizer/oxygen scavenger increases the temperature stability of gelled fracturing fluids, resulting in a long-lasting, high-viscosity fluid at operational temperatures. At relatively higher temperatures above 180F, dissolved oxygen in the fracturing fluid tends to form oxygen radicles by cleavage of oxygen molecule. The formed oxygen radicles can attack the polymer chain and may reduce the viscosity of the fluid system. However the gel stablilizer/oxygen scavenger helps in scavenging the oxygen and prevents the polymer degradation by preventing the scission of oxygen molecules. In one embodiment, the gel stabilizer/oxygen scavenger may comprise from about 3 lb/1000 gal to about 50 lb/1000 gal of the fracking fluid, and in one aspect, the gel stabilizer/oxygen scavenger comprises about 6 gal/1000 gal of water.

In some embodiments, the fracking fluid also may comprise a conventional crosslinker, such as a cross-linking polysaccharide. A commercially available example of a crosslinker is shown in Table I, below. The crosslinker makes the fracking fluid more stable and changes the viscous fluid to a pseudoplastic fluid.

In one embodiment, the crosslinker may be present in the range from about 0.5 gal/1000 gal to about 10 gal/1000 gal of the fracking fluid, and in one aspect the concentration of the crosslinker comprises about 5 gal/1000 gal of water.

In yet other embodiments of the fracking fluid may comprise potassium chloride (KCl), which is used to control clay in the fracking fluid. In one embodiment, the KCl may be present in the range from about 0.01% w/v to about 24% w/v of the fracking fluid, and in one aspect the concentration of the KCl comprises about 2% w/v of the fracking fluid. It should be understood that other salts, such a NaCl, NaBr, KBr, ZnBr₂, sodium formate, potassium formate, CaBr₂, CaCl₂, may be used in place of KCl

Experimental

Rheology tests were conducted on a standard fracturing fluid where the first fluid did not include the nonionic glycoside crosspolymer surfactant and the second test fluid did include the nonionic glycoside. Table I shows the components of the two fracturing fluids, as follows:

TABLE I

| | | Concentration | Concentration |
|---|---|---|---|
| | Additive | Test 1 | Test 2 |
| 1 | Tap Water | Base Fluid | Base Fluid |
| 2 | Aldacide ® G-biocide | 0.1 gal/1000 gal | 0.1 gal/1000 gal |
| 3 | KCL-clay controller | 2% w/v | 2% w/v |
| 4 | WG-11 TM-hydroxylpropyl | 40 lb/1000 gal | 40 lb/1000 gal |
| | guar | | |
| 5 | BA-20 TM-pH buffer | 0.2 gal/1000 gal | 0.2 gal/1000 gal |
| 6 | Poly Suga ®Mulse D9 | 0.0 gal/1000 gal | 2.0 gal/1000 gal |
| 7 | BA-40LTM-pH buffer | 2.5 gal/1000 gal | 2.5 gal/1000 gal |
| 8 | MO-67TM-pH buffer | 2.5 gal/1000 gal | 2.5 gal/1000 gal |
| 9 | Gel Sta LTM-oxygen | 6.0 gal/1000 gal | 6.0 gal/1000 gal |
| | scavenager | | |
| 10 | ViCon NFTM-breaker | 2.0 gal/1000 gal | 2.0 gal/1000 gal |
| 11 | CL-28MTM-optional | 5.0 gal/1000 gal | 5.0 gal/1000 gal |
| | crosslinker | | |

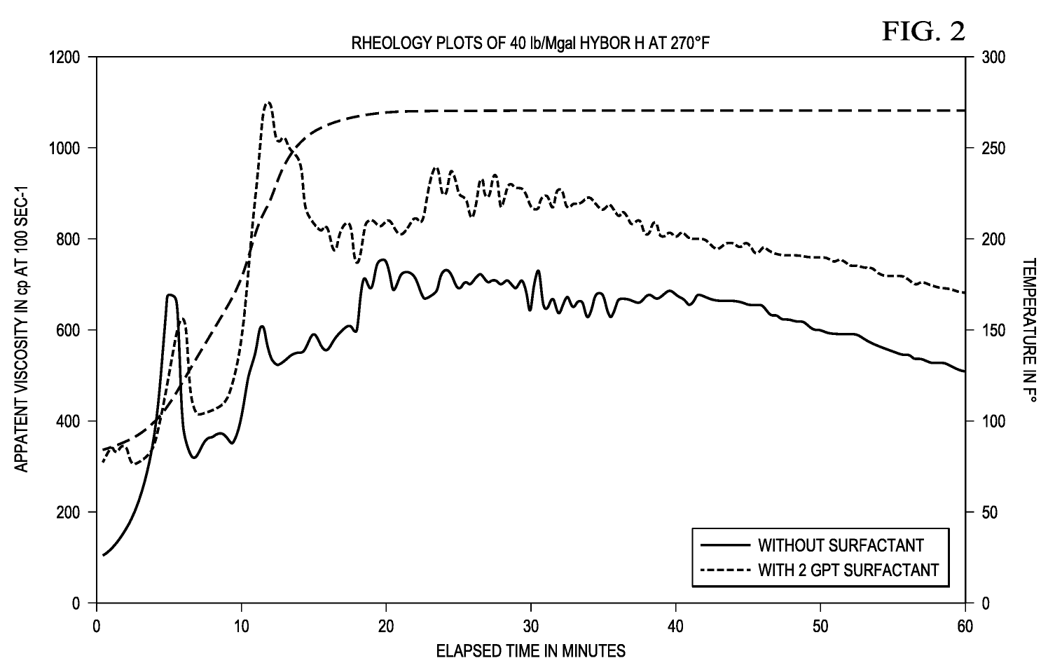

FIG. 2 shows a rheology plot comparing the fluid of Test 1 (without the nonionic glycoside crosspolymer) with the fluid of Test 2 (with the nonionic alkyl glycoside crosspolymer). As seen from FIG. 2, the fracturing fluid that contained the nonionic alkyl glycoside crosspolymer had a significantly higher viscosity at higher temperatures over the given period than the fluid that did not include the nonionic alkyl glycoside crosspolymer. From FIG. 2, it is seen that the addition of the nonionic alkyl glycoside crosspolymer surfactant helped in improving rheology by around 150 cp viscosity raise at 270° F. and 100 shear rate, which in turn, improved the thermal stability.

A foam test was also conducted using he nonionic alkyl glycoside, decyl-glucoside sorbitan oleate crosspolymer, which resulted in a solution having a surfactant concentration of about 1 gal/1000 gal. However, in large scale applications, the surfactant concentration may be present in a range from about 0.1 gal/1000 gal to about 25 gal/1000 gal. The test solution had good foaming properties (initial foam quality, volume percentage of gas, such as CO₂, N₂ or any other gas, in the foam, of almost 73%), that was stable and had not reached half-life after three hours. The results of this foam test are shown in Table II, as follows:

TABLE II

| Additive used | Quantity | |
|---|---|---|
| HPG | 10 | lb/Mgal |
| Poly suga Mulse D9 | 2 | gal/mgal |

The extended foam life of the nonionic alkyl glycoside crosspolymer in the fracturing solution is beneficial because foaming of the fluid helps in reducing required water amount in operation and minimize the fluid invasion in to the formation by acting as fluid loss control with a special network.

A non-emulsification test was also performed, wherein 2 gal/1000 gal of the nonionic alkyl glycoside crosspolymer, decyl-glucoside sorbitan oleate crosspolymer, was mixed with crude oil from Oman and a 15% HCl fluid. The test showed that within 60 seconds, a complete phase separation of the oil from the fluid had taken place, versus no separation when the crosspolymer was not present.

Another non-emulsification test was performed, wherein 2 gal/1000 gal of the nonionic alkyl glycoside crosspolymer, decyl-glucoside sorbitan oleate crosspolymer, was mixed with a paraffinic crude oil and the fracturing fluid from Table I (Test 2). The test showed that within 10 seconds, a complete separation of the oil from the fluid had taken place, versus no separation when the crosspolymer was not present.

Another non-emulsification test was performed, wherein 2 gpt of the nonionic alkyl glycoside crosspolymer, decyl-glucoside sorbitan oleate crosspolymer, was mixed with a crude oil from Oman and a Slick water mixture. The test showed that within 60 seconds, a complete phase separation of the oil from the fluid had taken place, versus no separation when the crosspolymer was not present. The non-emulsification property of the surfactant helps in preventing the emulsion formation due to the presence of fluid and oil contact downhole. If emulsion formation occurs downhole, production depletes and reservoir pressure will also deplete faster which makes it in-efficient, so it is desirable to inhibit emulsion formation.

A bio degradation test was also performed, wherein 2 mg/L of the proposed nonionic alkyl glycoside crosspolymer, decyl-glucoside sorbitan oleate crosspolymer was taken in an aerobic medium. The percentage degradation is shown in Table III.

TABLE III

| Time (Days) | Degradation (%) |
|---|---|
| 7 | 81.1 |
| 14 | 90.4 |
| 21 | 98.6 |
| 28 | 99.5 |

Based on Table III, the proposed nonionic alkyl glycoside crosspolymer exhibited good bio-degradability, which addresses environmental concerns and applicable environmental regulations.

Embodiments Disclosed Herein Comprise:

A well fracturing pad fluid, comprising: a gelling agent; one or more buffering agents; a viscosity breaker; a biocide; a nonionic alkyl glycoside; and water, present in the range from about 98% to about 99.99% by volume of the well fracturing pad fluid.

Another embodiment comprises a method of preparing a well fracturing slurry. This embodiment comprises: combining a gelling agent with water; combining one or more buffering agents with the water; combining a viscosity breaker with the water; combining a biocide with the water; combining a nonionic alkyl glycoside crosspolymer with the water to form a fracturing pad fluid, wherein the water comprises from about 90% to about 99% by volume of the fracturing pad fluid; mixing the fracturing pad fluid with a proppant to form the well fracturing slurry.

Another embodiment comprises a method of fracturing a geological formation. This method embodiment comprises preparing a fracturing slurry, comprising, a gelling agent water; one or more buffering agents with said water; a viscosity breaker; a biocide; and a nonionic alkyl glycoside crosspolymer, wherein water comprises from about 90% to about 99.9% by volume of the fracturing slurry to form a fracturing pad fluid. The method further comprises injecting the fracturing pad fluid under pressure into a geological formation to form fractures therein; mixing a proppant with the fracturing pad fluid to form a slurry, and injecting theslurry into said fractures.

Each of the foregoing embodiments may comprise one or more of the following additional elements singly or in combination, and neither the example embodiments or the following listed elements limit the disclosure, but are provided as examples of the various embodiments covered by the disclosure:

Element 1: wherein the gelling agent, is present in the range from about 5 lb/1000 gal to about 500 lb/1000 gal of the fracturing fluid, the one or more buffering agents is present in the range from about 0.1 gal/1000 gal to about 20 gal/1000 gal of the fracturing fluid, the viscosity breaker is present in the range from about 0.01 gal/1000 gal to about 30 gal/1000 gal of the fracturing fluid, and the nonionic alkyl glycoside crosspolymer is present in the range from about 0.01 gal/1000 gal to about 10 gal/1000 gal of the fracturing.

Element 2: wherein the nonionic alkyl glycoside is a sorbitan oleate bonded to one or more glucosides to form the nonionic alkyl glycoside.

Element 3: wherein the sorbitan oleate is bonded to a decylglucoside on both sides of the sorbitan oleate structure to form decylglucoside sorbitan oleate crosspolymer.

Element 4: wherein the decylglucoside sorbitan oleate crossploymer has a molecular structure as follows:

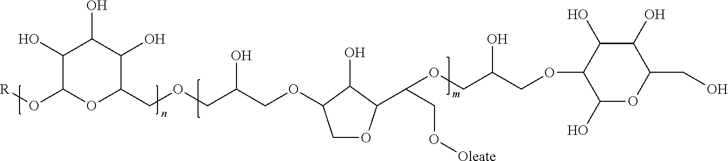

wherein, “n” may range from 1 to 50 and “m” may range from 1 to 50.

Element 5: wherein the gelling agent is hydroxyl-propyl.

Element 6: further comprising a crosslinking polysaccharide.

Element 7: further comprising an oxygen scavenging compound.

Element 8: wherein the proppant is present in the range from about 0.5 lb/gal to about 12 lb/gal of the slurry, the gelling agent, is present in the range from about 5 lb/1000 gal to about 500 lb/1000 gal of the slurry, the one or more buffering agents is present in the range from about 0.01 gal/1000 gal to about 5 gal/1000 gal of the slurry; the viscosity breaker is present in the range from about 0.01 gal/1000 gal to about 30 gal/1000 gal of the slurry; and the nonionic alkyl glycoside crosspolymer is present in the range from about 0.01 gal/1000 gal to about 10 gal/1000 gal of the slurry.

Element 9: wherein the nonionic alkyl glycoside is a sorbitan oleate bonded to one or more glucosides to form the nonionic alkyl glycoside.

Element 10: wherein the sorbitan oleate is bonded to a decylglucoside on both sides of the sorbitan oleate structure to form decylglucoside sorbitan oleate crosspolymer.

Element 11: wherein the decylglucoside sorbitan oleate crossploymer has a molecular structure as follows:

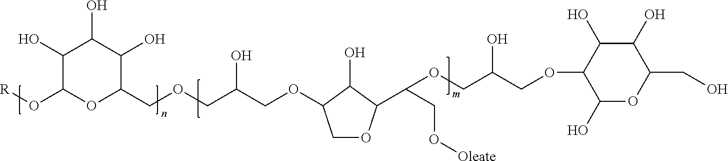

wherein, wherein, “n” may range from 1 to 50 and “m” may range from 1 to 50.

Element 12: further comprising a crosslinking polysaccharide and an oxygen scavenger.

Element 13: wherein the proppant is present in the range from about 0.5 lb/gal to about 12 lb/gal of the slurry, the gelling agent, is present in the range from about 5 lb/1000 gal to about 500 lb/1000 gal of the slurry, the one or more buffering agents is present in the range from about 0.01 gal/1000 gal to about 5 gal/1000 gal of the slurry; the viscosity breaker is present in the range from about 0.01 gal/1000 gal to about 30 gal/1000 gal of the slurry; and the nonionic alkyl glycoside crosspolymer is present in the range from about 0.01 gal/1000 gal to about 10 gal/1000 gal of the slurry.

Element 14: wherein the nonionic alkyl glycoside is a sorbitan oleate bonded to one or more glucosides to form the nonionic alkyl glycoside.

Element 15: wherein the sorbitan oleate is bonded to a decylglucoside on both sides of the sorbitan oleate structure to form decylglucoside sorbitan oleate crosspolymer.

Element 16: wherein the decylglucoside sorbitan oleate crossploymer has a molecular structure as follows:

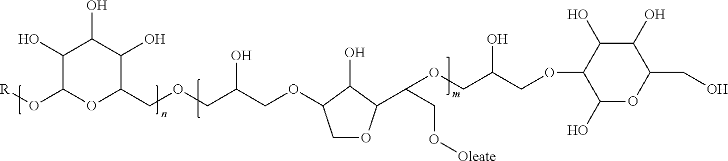

wherein, wherein, “n” may range from 1 to 50 and “m” may range from 1 to 50.

Element 17: further comprising a comprising a crosslinking polysaccharide and an oxygen scavenger.

The foregoing listed embodiments and elements do not limit the disclosure to just those listed above.

Those skilled in the art to which this application relates will appreciate that other and further additions, deletions, substitutions and modifications may be made to the described embodiments.

1. A well fracturing pad fluid, comprising:
a gelling agent;
one or more buffering agents;
a viscosity breaker;
a nonionic alkyl glycoside; and
water, comprising from about 98% to about 99.99% by volume of said fracturing fluid.

2. The well fracturing pad fluid of claim 1, wherein:
said gelling agent, is present in the range from about 5 lb/1000 gal to about 500 lb/1000 gal of said fracturing fluid;
said one or more buffering agents is present in the range from about 0.1 gal/1000 gal to about 20 gal/1000 gal of said fracturing fluid;
said a viscosity breaker is present in the range from about 0.01ga1/1000 gal to about 30 gal/1000 gal of said fracturing fluid; and
said nonionic alkyl glycoside crosspolymer is present in the range from about 0.01 gal/1000 gal to about 10 gal/1000 gal of said fracturing fluid.

3. The well fracturing pad fluid of claim 1, wherein said nonionic alkyl glycoside is a sorbitan oleate bonded to one or more glucosides to form said nonionic alkyl glycoside.

4. The well fracturing pad fluid of claim 3, wherein said sorbitan oleate is bonded to a decylglucoside on both sides of said sorbitan oleate structure to form decylglucoside sorbitan oleate crosspolymer.

5. The well fracturing pad fluid of claim 3, wherein said decylglucoside sorbitan oleate crossploymer has a molecular structure as follows: 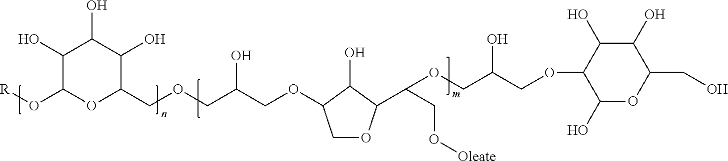
wherein, wherein, “n” may range from 1 to 50 and “m” may range from 1 to 50.

6. The well fracturing pad fluid of claim 1, wherein said gelling agent is hydroxyl-propyl.

7. The well fracturing pad fluid of claim 1, further comprising a crosslinking polysaccharide.

8. The well fracturing pad fluid of claim 1, further comprising an oxygen scavenging compound.

9. A method of preparing a well fracturing slurry, comprising:
mixing a gelling agent with water;
mixing one or more buffering agents with said water;
mixing a viscosity breaker with said water;
mixing a nonionic alkyl glycoside crosspolymer with said water, wherein said water comprises from about 90% to about 99.9% by volume of said fracturing slurry to form a fracturing pad fluid and mixing said fracturing pad fluid with a proppant to form said well fracturing slurry.

10. The method of claim 9, wherein:
said propant is present in the range from about 0.5 lb/1000 gal to about 12 lb/1000 gal of said slurry;
said gelling agent, is present in the range from about 5 lb/1000 gal to about 500 lb/1000 gal of said slurry;
said one or more buffering agents is present in the range from about 0.01 gal/1000 gal to about 5 gal/1000 gal of said slurry;
said a viscosity breaker is present in the range from about 0.01 gal/1000 gal to about 30 gal/1000 gal of said slurry; and
said nonionic alkyl glycoside crosspolymer is present in the range from about 0.01 gal/1000 gal to about 10 gal/1000 gal of said slurry.

11. The method of claim 9, wherein said nonionic alkyl glycoside is a sorbitan oleate bonded to one or more glucosides to form said nonionic alkyl glycoside.

12. The method of claim 11, wherein said sorbitan oleate is bonded to a decylglucoside on both sides of said sorbitan oleate structure to form decylglucoside sorbitan oleate cros spolymer.

13. The method of claim 11, wherein said decylglucoside sorbitan oleate crossploymer has a molecular structure as follows: 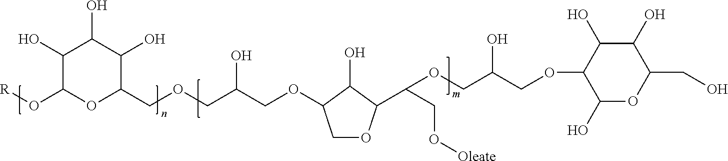
wherein, “n” may range from 1 to 50 and “m” may range from 1 to 50

14. The method of claim 9, further comprising a crosslinking polysaccharide and an oxygen scavenger.

15. A method of fracturing a geological formation, comprising:
providing a fracturing slurry, comprising,
a gelling agent with water;
one or more buffering agents with said water;
a viscosity breaker with said water; and
a nonionic alkyl glycoside crosspolymer with said water to form a fracturing pad fluid, wherein water comprises from about 90% to about 99.9% by volume of said fracturing paid fluid;
injecting said fracturing pad fluid under pressure into a geological formation to form one or more fractures therein;
mixing a proppant with said fracturing pad fluid to form a slurry; and
injecting said slurry into said one or more fractures.

16. The method of claim 15, wherein:
said proppant is present in the range from about 0.5 lb/gal to about 12 lb/gal of said slurry;
said gelling agent, is present in the range from about 5 lb/1000 gal to about 500 lb/1000 gal of said slurry;
said one or more buffering agents is present in the range from about 0.01 gal/1000 gal to about 5 gal/1000 gal of said slurry;
said a viscosity breaker is present in the range from about 0.01 gal/1000 gal to about 30 gal/1000 gal of said slurry; and
said nonionic alkyl glycoside crosspolymer is present in the range from about 0.01 gal/1000 gal to about 10 gal/1000 gal of said slurry.

17. The method of claim 15, wherein said nonionic alkyl glycoside is a sorbitan oleate bonded to one or more glucosides to form said nonionic alkyl glycoside.

18. The method of claim 17, wherein said sorbitan oleate is bonded to a decylglucoside on both sides of said sorbitan oleate structure to form decylglucoside sorbitan oleate cros spolymer.

19. The method of claim 17, wherein said decylglucoside sorbitan oleate crossploymer has a molecular structure as follows: 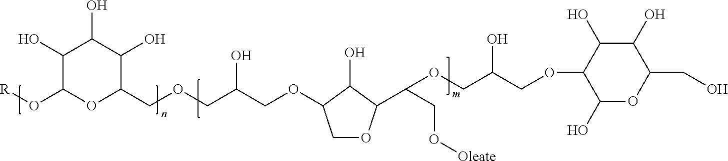
wherein, “n” may range from 1 to 50 and “m” may range from 1 to 50.

20. The method of claim 15, further comprising a comprising a crosslinking polysaccharide and an oxygen scavenger.
